(19) United States
(12) Patent Application Publication
(10) Pub. No.: US 2011/0270548 A1
(43) Pub. Date: Nov. 3, 2011

(54) AUTOMATED VERIFICATION AND ESTIMATION OF QUIESCENT POWER SUPPLY CURRENT

(75) Inventors: Songlin Zuo, San Diego, CA (US); Michael Laisne, Encinitas, CA (US); Hailong Cui, San Diego, CA (US); Dennis J. Mahon, San Diego, CA (US); Sriram Satakopan, Bangalore (IN); Shrivatsa Prahallada, Bangalore (IN)

(73) Assignee: QUALCOMM INCORPORATED, San Diego, CA (US)

(21) Appl. No.: 13/095,070

(22) Filed: Apr. 27, 2011

Related U.S. Application Data
(60) Provisional application No. 61/329,475, filed on Apr. 29, 2010.

(51) Int. Cl. G06F 19/00

(52) U.S. Cl. 702/60

(57) ABSTRACT

Procedures are disclosed to automate constraint and power mode (PM) setup determination for quiescent power supply current (I_{DDQ}) testing of a semiconductor design. Starting with known constraints and PM setup, if available, an estimation is run to obtain minimum, lower bound (LB), expected, upper bound (UB), and maximum I_{DDQ} estimates for individual cells. The estimates are sorted by range (UB-LB), and by elevation (expected-minimum). A constraint is added to control the power of the cell with the highest range. A constraint or a PM entry is added to reduce elevation of the cell with the highest elevation, based on a predetermined property of the cell. With the adjusted constraints and PM setup, the steps are repeated. Iteration continues until (1) the top cells are not custom cells, memories, or macros, or (2) the contributions of the top cells to the design's range and elevation are below predetermined limits.

### CROSS-REFERENCE TO RELATED APPLICATION

This application claims priority from U.S. Provisional Patent Application Ser. No. 61/329,475, entitled AUTOMATED VERIFICATION AND ESTIMATION OF QUIESCENT POWER SUPPLY CURRENT, filed on Apr. 29, 2010, which is hereby incorporated by reference in its entirety as if fully set forth herein, including Figures, Tables, and Claims, if present.

### BACKGROUND

1. Field

The present invention relates generally to integrated circuit testing. More particularly, in aspects, the invention relates to quiescent supply current testing of integrated circuits. The present invention also relates to power domain definition representation in circuit design and testing.

2. Background

Quiescent supply current (I_{DDQ}) measurement and verification is an effective method for testing Complementary Metal-Oxide Semiconductor (CMOS) and other electronic circuits. Quiescent supply current testing can detect defects that are missed by scan testing, such as gate-oxide defects, shorts between transistor terminals and other bridging faults, partial defects detrimental to reliability and durability but that may or may not affect functionality, delay faults, stuck-open faults, and other faults.

For scan testing, a circuit (e.g., an integrated circuit or IC) is configured into a scan test mode and a scan chain sequence is (or, more typically, scan chain sequences are) sequentially clocked into an input to preprogram flip-flops or other storage elements of the circuit. After the scan chain sequence is sequentially propagated into the flip-flops, the initial state of the circuit is set. The circuit is switched into a quasi-functional mode for at least one clock cycle to exercise its logic, and the results are sequentially clocked out of an output of the circuit. The results of each scan are compared to the expected values of the scan results. The expected values may have been derived from a simulation.

For I_{DDQ} testing, the circuit is powered up and placed in a static mode after a test vector (e.g., one or more scan chain sequences stimulating the circuit at the same time) is shifted into the flip-flops, as has been described above; or the circuit, including the cells in scan chain, is programmed in a mode other than the scan mode. The clock is halted to eliminate the power drain resulting from switching. This is the quiescent state of the circuit. While in this state, the quiescent supply current of the circuit is measured and compared to a predetermined threshold. (There are other techniques to determine pass/fail of the circuit, such as delta-I_{DDQ}, ratio, wafer level evaluation, etc.) A current value below (or at or below) the threshold indicates a passing circuit. A current value above the threshold indicates a failed circuit, because, in CMOS logic, the only current flowing through a passing circuit is the leakage current. The aggregate of the normal cell leakage currents of a fault-free device is the normal quiescent current for that device. A defect may generate a greater level of current, i.e., a current level increase over the normal quiescent current level.

Quiescent supply current vector verification and debugging may take considerable time and effort. Various problems have been encountered in such troubleshooting processes, and different tools and methodologies have been devised to address them. For pre-silicon I_{DDQ} vector verification, a modular approach may be adopted. I_{DDQ} is estimated for each vector based on leakage libraries of cells, and cell constraints can be verified automatically. Various methods and analysis tools have been developed to identify the root causes of post-silicon I_{DDQ} vector testing problems. Scan cell and net value analyses may identify critical scan cells and nets, which will result in either passing or failing of a particular I_{DDQ} pattern, possibly revealing the source of the excessive leakage. These methodologies are often successful for I_{DDQ} vector debug and I_{DDQ} diagnosis.

I_{DDQ} testing is a valuable test for low power CMOS circuits, since a small number of I_{DDQ} vectors can achieve test effectiveness comparable to that of a much larger number of functional or other structural tests. In recent years, the technological trend of scaling down IC geometries to deep sub-micron range has resulted in a considerable increase in the difficulty of I_{DDQ} test development. Leakage current per gate is increasing with the scale reduction, and the increased gate count directly drives the increase in the total device leakage. The variability in leakage current, as measured, for example, by standard deviation for defect-free chips, has also been increasing, while defect-induced leakage has been decreasing. As a result, certain methodologies for identifying these defects may be less efficient than before, or even completely ineffective.

Low power consumption is an important requirement for devices used in mobile applications, such as wireless communications, and the market for devices designed for mobile applications is growing fast. Various methodologies have been devised or explored to reduce power consumption in these applications, including power consumption through static leakage. Along with the physical geometries, power supply voltage is also scaling downward; this and various other design and fabrication techniques have helped to offset the power consumption increases caused by smaller feature size and the growing number of transistors per device. Small feature size devices are suitable for I_{DDQ} testing. Chips with around several milliamperes or lower current leakage can still be verified using by conventional I_{DDQ} testing techniques. In fact, I_{DDQ} verification provides an important means for structurally testing for leakage defects that might have substantial detrimental effect on the sleep time of the end product.

In I_{DDQ} vector generation, verification, and debugging, various problems have been encountered, including custom cell design issues, implementation issues, constraint issues, and other issues. These issues also contribute to reduced effectiveness of traditional debugging techniques.

The range and variability of the theoretically expected I_{DDQ} value (i.e., expected I_{DDQ} value excluding process variation) are preferably small for the I_{DDQ} vectors selected for testing. If the range is too large, then individual faults might not increase I_{DDQ} beyond the upper limit of the range. Similarly, if the absolute value of I_{DDQ} is relatively large, then an individual fault may result in a small percentage increase in I_{DDQ} and thus evade detection. To keep the range and/or the absolute value small, certain cells with wide I_{DDQ} ranges corresponding to legitimate input states are programmed by I_{DDQ} vectors into one or a few power modes; in each of these power modes the cells are programmed into a particular input state and the I_{DDQ} range is decreased. Some cells, particularly non-pure-digital and/or custom cells, need to be put into the low power mode because of their high power consumption in the course of normal operation (otherwise their high power consumption could swamp quiescent current increase due to a fault). The cell controls corresponding to the lowest power or sleep mode are known as constraints; constraints are set to reduce I_{DDQ}. Cell controls corresponding to power modes (PMs) other than the lowest power mode are referred to as power mode setup. Power mode setup may be used to reduce the range of I_{DDQ}.

A set of constraints and power mode setup (which defines the known power modes) of the cell is therefore necessary for I_{DDQ} testing. Unfortunately, accurate constraints and power mode setup are not always known in advance. A need thus exists in the art for ways to automate the process of determining I_{DDQ} testing constraints and power mode setup, particularly in the pre-silicon time frame.

Another need exists in the art to facilitate definition of power domains for circuit design and testing.

### SUMMARY

Embodiments disclosed herein may address the above stated needs by providing an automated and accurate way for I_{DDQ} verification and prediction. In an embodiment, a design netlist is processed and flattened to the cell or macro level at which constraints, power mode setup, and leakage information are defined. Then, the known constraints and setup for each PM are translated to a “pseudo” (or “dummy” or virtual) design state, and the I_{DDQ} is calculated for each power domain and power level, based on cell leakage information, together with upper and lower bounds, and the absolute maximum and minimum possible I_{DDQ}. As in a “virtual” I_{DDQ} test, if the gap between the upper and lower bounds (i.e., the range) for I_{DDQ} is very wide, this may indicate insufficiency of I_{DDQ} constraint(s) or power mode separation (because a mixture of two or more power modes may also result in a wide I_{DDQ} range); if the I_{DDQ} prediction along with the upper to lower bound range is not properly located in the maximum to minimum I_{DDQ} graph, this may indicate insufficiency or inaccuracy of I_{DDQ} PM setup information. I_{DDQ} constraint and PM setup problems can generally be attributed to cells contributing the most differences between the upper and lower bounds, or contributing the most deviation of estimated I_{DDQ} from its expected location in the maximum to minimum I_{DDQ} graph, and therefore new constraints and/or PM setup can be identified for such cells. The verification and fix for constraints and PM setup may be performed not only before arrival of first silicon, but also before I_{DDQ} vector generation, potentially reducing the cost of I_{DDQ} verification. After I_{DDQ} vector generation, the vectors are simulated and the chip states are saved. The chip states are then combined with the design, and broken down to cell input states. Afterwards, constraints and PM setup are verified for each vector, and I_{DDQ} is estimated. The calculated I_{DDQ} range for each specific I_{DDQ} vector should fall within the range of “virtual” or “dummy” estimation, and possibly be more specific. This enables any exceptions to be traced back to individual cells and, thus, the root causes of the exceptions may be identified more easily.

In an embodiment, a method of determining power state control information for quiescent power supply (IDDQ) testing of a circuit includes performing, by a computing system, the following steps:

(1) running an estimation to obtain IDDQ estimates, the IDDQ estimates comprising, for each cell of a power domain of the circuit, an absolute minimum estimate (MIN), a lower bound estimate (LB), a probable estimate, and an upper bound estimate (UB), the step of running an estimation using a current constraint information and a current power mode (PM) setup information;
(2) identifying one or more first cells of the predetermined domain with highest gap values, a gap value of a cell being a difference between UB and LB for the cell;
(3) determining whether a need exists to add to current constraint information based on one or more predetermined constraint criteria, the one or more predetermined constraint criteria being based on the highest gap values;
(4) in response to existence of the need to add to the current constraint information, adding one or more constraints to the current constraint information;
(5) first repeating the steps of running, identifying one or more first cells, determining whether the need exists to add to current constraint information, and, in response to the existence of the need to add to current constraint information, adding one or more constraints to the current constraint information; and
(6) performing IDDQ testing on the circuit in response to non-existence of the need to add to the current constraint information.

In an embodiment, an article of manufacture includes at least one machine readable medium storing instructions for configuring a computing system to perform steps of a method of determining power state control information for quiescent power supply (IDDQ) testing of a circuit. The steps of the method include these:

(1) running an estimation to obtain IDDQ estimates, the IDDQ estimates comprising, for each cell of a power domain of the circuit, an absolute minimum estimate (MIN), a lower bound estimate (LB), a probable estimate, and an upper bound estimate (UB), the step of running an estimation using a current constraint information and a current power mode (PM) setup information;
(2) identifying one or more first cells of the predetermined domain with highest gap values, a gap value of a cell being a difference between UB and LB for the cell;
(3) determining whether a need exists to add to current constraint information based on one or more predetermined constraint criteria, the one or more predetermined constraint criteria being based on the highest gap values;
(4) in response to existence of the need to add to the current constraint information, adding one or more constraints to the current constraint information;
(5) first repeating the steps of running, identifying one or more first cells, determining whether the need exists to add to current constraint information, and, in response to the existence of the need to add to current constraint information, adding one or more constraints to the current constraint information; and
(6) performing IDDQ testing on the circuit in response to non-existence of the need to add to the current constraint information.

In an embodiment, a computing system includes at least one processor and at least one memory storing instructions. When the instructions are executed by the at least one processor, the processor configures the computing system to perform a method for determining power state control information for quiescent power supply (IDDQ) testing of a circuit. The method includes the following steps:

(2) running an estimation to obtain IDDQ estimates, the IDDQ estimates comprising, for each cell of a power domain of the circuit, an absolute minimum estimate (MIN), a lower bound estimate (LB), a probable estimate, and an upper bound estimate (UB), the step of running an estimation using a current constraint information and a current power mode (PM) setup information;
(2) identifying one or more first cells of the predetermined domain with highest gap values, a gap value of a cell being a difference between UB and LB for the cell;
(3) determining whether a need exists to add to current constraint information based on one or more predetermined constraint criteria, the one or more predetermined constraint criteria being based on the highest gap values;
(4) in response to existence of the need to add to the current constraint information, adding one or more constraints to the current constraint information; and
(5) first repeating the steps of running, identifying one or more first cells, determining whether the need exists to add to current constraint information, and, in response to the existence of the need to add to current constraint information, adding one or more constraints to the current constraint information.

In an embodiment, a method of determining power state control information for quiescent power supply (IDDQ) testing of a circuit includes the following steps performed by a computing system:

(1) step for obtaining IDDQ estimates, the IDDQ estimates comprising, for each cell of a power domain of the circuit, an absolute minimum estimate (MIN), a lower bound estimate (LB), a probable estimate, and an upper bound estimate (UB), the step of running an estimation using a current constraint information and a current power mode (PM) setup information;
(2) step for identifying one or more first cells of the predetermined domain with highest gap values;
(3) step for determining whether a need exists to add to current constraint information based on one or more predetermined constraint criteria, the one or more predetermined constraint criteria being based on the highest gap values;
(4) in response to existence of the need to add to the current constraint information, step for adding one or more constraints to the current constraint information;
(5) repeating the step for obtaining, step for identifying one or more first cells, step for determining whether the need exists to add to current constraint information, and, in response to the existence of the need to add to current constraint information, step for adding one or more constraints to the current constraint information; and
(6) step for performing IDDQ testing on the circuit in response to non-existence of the need to add to the current constraint information.

In an embodiment, a method of simulating an integrated circuit includes the following steps:
(1) reading an IDDQ Vector Analysis (IVA) format definition of at least one power domain of the integrated circuit;
(2) simulating cells of the integrated circuit using the IVA format definition of at least one power domain of the integrated circuit; and
(3) at least one of (1) displaying results of the step of simulating and (2) storing the results of the step of simulating.

In an embodiment, a method of performing leakage current testing of an integrated circuit, includes these steps:
(1) reading an IDDQ Vector Analysis (IVA) format definition of at least one power domain of the integrated circuit;
(2) driving the integrated circuit with predetermined vectors;
(3) determining leakage current of cells of the integrated circuit using the IVA format definition of at least one power domain of the integrated circuit; and
(5) at least one of (1) displaying results of the step of simulating and (2) storing the results of the step of simulating.

In an embodiment, a computing system includes at least one processor and at least one memory storing instructions. When the instructions are executed by the at least one processor of the computing system, the processor configures the computing system to perform a method of simulating an integrated circuit, the method including:

(1) reading an IDDQ Vector Analysis (IVA) format definition of at least one power domain of the integrated circuit;
(2) simulating cells of the integrated circuit using the IVA format definition of at least one power domain of the integrated circuit; and
(3) at least one of (1) displaying results of the step of simulating and (2) storing the results of the step of simulating.

In an embodiment, a computing system includes at least one processor and at least one memory storing instructions, wherein, when the instructions are executed by the at least one processor, the processor configures the computing system to perform a method of leakage current testing of an integrated circuit. The method includes:

(1) reading an IDDQ Vector Analysis (IVA) format definition of at least one power domain of the integrated circuit;
(2) driving the integrated circuit with predetermined vectors;
(3) determining leakage current of cells of the integrated circuit using the IVA format definition of at least one power domain of the integrated circuit; and
(4) at least one of (1) displaying results of the step of simulating and (2) storing the results of the step of simulating.

Further scope of the applicability of the present methods, apparatus, and articles of manufacture will become apparent from the detailed description, claim(s), and drawings. It should be understood, however, that the detailed description and specific examples, while indicating one or more preferred embodiments, are given by way of illustration only, since various changes and modifications within the spirit and scope of the invention will become apparent to those skilled in the art.

### BRIEF DESCRIPTION OF THE DRAWINGS

FIG. 1 illustrates selected aspects of I_{DDQ} flow debugging;

FIG. 2A illustrates selected aspects of I_{DDQ} vector analysis process flow;

FIG. 2B illustrates selected aspects of process flow of I_{DDQ} estimation for a digital domain containing selected cells and memories;

FIG. 2C illustrates selected aspects of process flow of I_{DDQ} estimation for a digital domain where processing of digital cell leakage is combined with processing of memory leakage;

FIG. 3 illustrates selected aspects of I_{DDQ} Vector Analysis work flow;

FIG. 4 illustrates selected steps and decisions of a process for automating determination of constraints and/or power mode setup;

FIG. 5 illustrates selected steps and decisions of a process for automating the determination of the initial information in the constraint file;

FIG. 6 illustrates selected aspects of a format for power domain description and partitioning;

FIG. 7 illustrates definition of the format of FIG. 6 in Backus-Naur Form (BNF); and

FIGS. 8A and 8B illustrate definition of the format of FIG. 6 in Extended Backus-Naur Form (EBNF).

### DETAILED DESCRIPTION

The detailed description set forth below in connection with the appended drawings is intended as a description of exemplary embodiments and is not intended to represent the only embodiments in which the present invention can be practiced. The detailed description includes specific details for the purpose of providing a thorough understanding of the present invention. It will be apparent to those skilled in the art, however, that the present invention may be practiced without certain details. In some instances, well known structures, devices, steps, and/or decisions are shown in block diagram form, in order to avoid obscuring the concepts of the present invention.

The words “embodiment,” “variant,” “implementation,” “example,” and similar expressions are used to refer to a particular apparatus, process, or article of manufacture, and not necessarily to the same apparatus, process, or article of manufacture. Thus, “one embodiment” (or a similar expression) used in one place or context may refer to a particular apparatus, process, or article of manufacture; the same or a similar expression in a different place may refer to a different apparatus, process, or article of manufacture. The expressions “alternative embodiment,” “alternatively,” and similar phrases may be used to indicate one or several of a number of different possible embodiments. The number of possible embodiments is not necessarily limited to two or any other quantity.

The word “exemplary” may be used herein to mean “serving as an example, instance, or illustration.” Any embodiment or variant described herein as “exemplary” is not necessarily to be construed as preferred or advantageous over other embodiments or variants. All of the embodiments and variants described in this document are exemplary embodiments and variants provided to enable persons skilled in the art to make and use the invention, and not necessarily to limit the scope of legal protection afforded the invention.

The terms “component,” “module,” “system,” and the like are intended to refer to a computer-related entity, which may be a hardware, software, or firmware entity. It can also refer to a combination of two or more of hardware, software, and/or firmware entities. For example, a component may be, but is not limited to being, a process running on a processor, a processor, an object, an executable, a thread of execution, a program, one or more computers, or other hardware/software/firmware. One or more components may reside within a process or thread of execution, and a component may be localized on one computer or distributed between or among two or more computers.

Aspects disclosed herein introduce systematic procedures for I_{DDQ} verification, prediction, and debugging. For pre-silicon verification of I_{DDQ} vectors, a modular approach may be adopted to process each I_{DDQ} vector. Vectors are simulated on a virtual tester (VT) to determine chip status, which is analyzed in combination with design netlists to extract the status of all primitive instances used in the design. I_{DDQ} is then estimated for each vector based on the input status of such primitive instances, according to cell leakage libraries. Input status of all modules, particularly custom modules requiring constraints and I_{DDQ} estimates, are verified to screen and identify possible problems in a design or in individual chips/circuits.

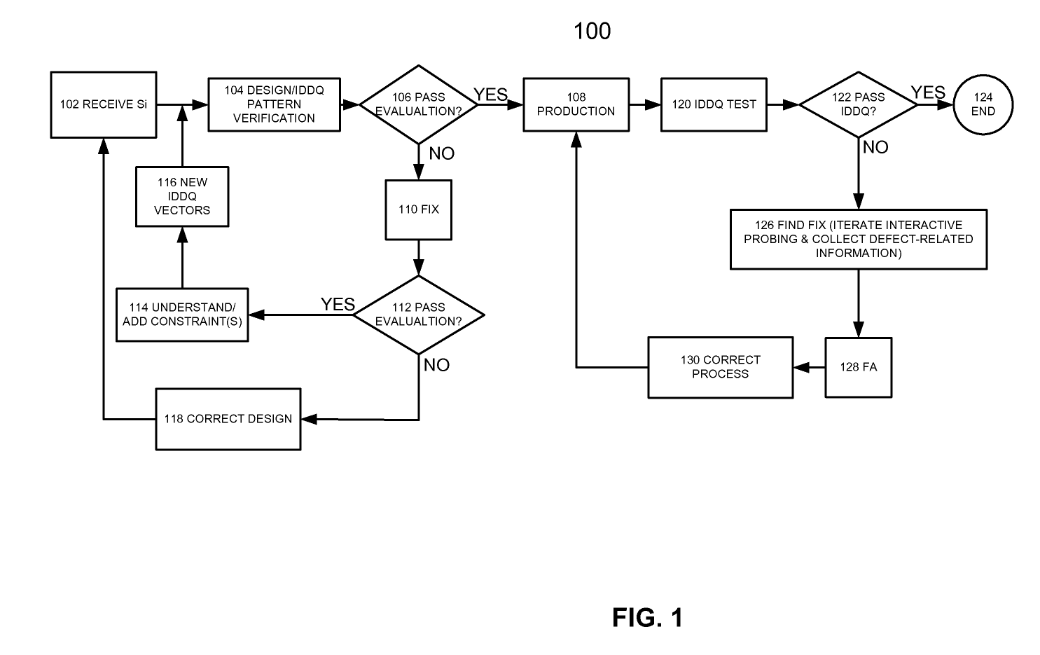

FIG. 1 illustrates selected aspects of I_{DDQ} flow debugging 100. In step 102, a sample of a semiconductor circuit is received. As shown in this Figure, the circuit can be a silicon circuit, but other technologies (e.g., gallium arsenide) are not necessarily excluded. In step 104, the circuit is submitted for design/I_{DDQ} pattern verification. If this design passes evaluation as determined in decision block 106, then the circuit may pass to an IC production process 108, from I_{DDQ} perspective. If the circuit fails the evaluation in the decision block 106, then a fix is attempted in step 110, to resolve to a constraint or a defect problem. If subsequent retesting indicates that the circuit passed, in decision block 112, then analysis is performed to understand and to add the constraint(s), in step 114. In step 116, new I_{DDQ} vectors are generated, consistent with the constraints (including the newly added constraint(s)), and the pre-production circuit is resubmitted for design/I_{DDQ} pattern verification in step 104. If the decision block 112 indicates a failure to pass evaluation, then a design or manufacturing issue is ascertained and the failure information is used to correct the design or manufacturing in step 118, with subsequent delivery of a new circuit design for testing, in the step 102.

With an acceptable design and vector constraints allowing the production circuit receipt in the step 108 after passing evaluation decision block 106, I_{DDQ} testing is performed to monitor for manufacturing defects, in step 120. If the circuit passes I_{DDQ} testing, as determined in decision block 122, then the process ends in flow point 124. Otherwise, an attempt is made to perform iterations of interactive probing and collect defect related information in step 126. Fault analysis (FA) is performed in step 128, the manufacturing process is corrected in step 130, and the flow returns to the production process of step 108.

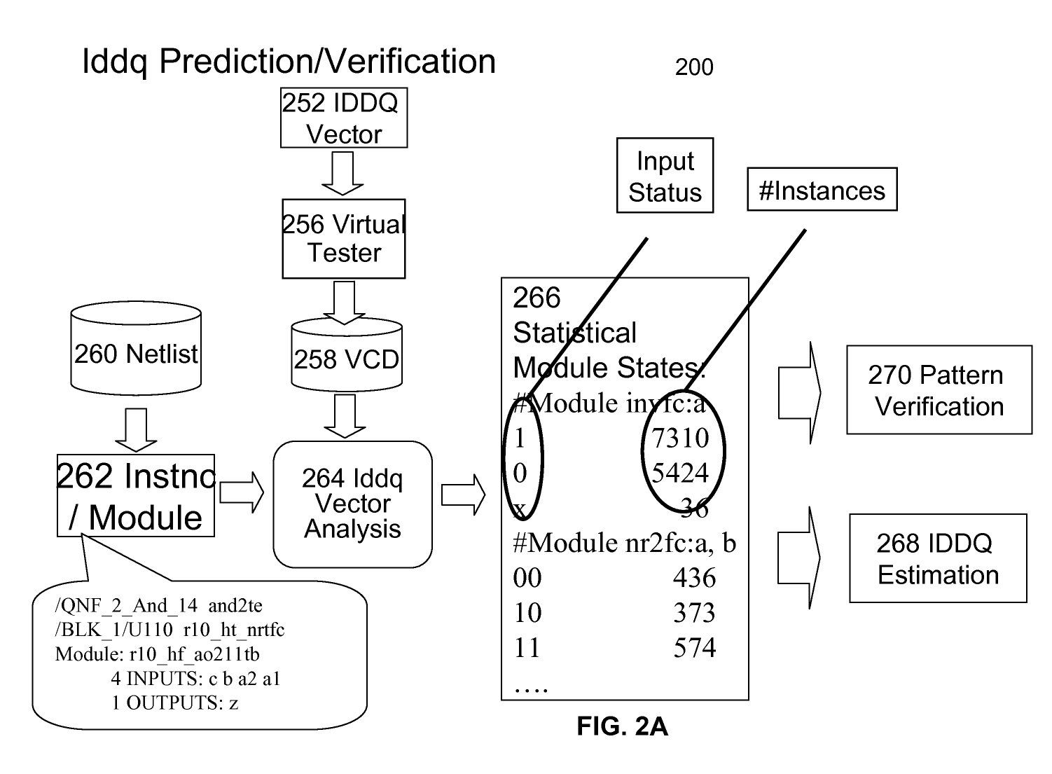

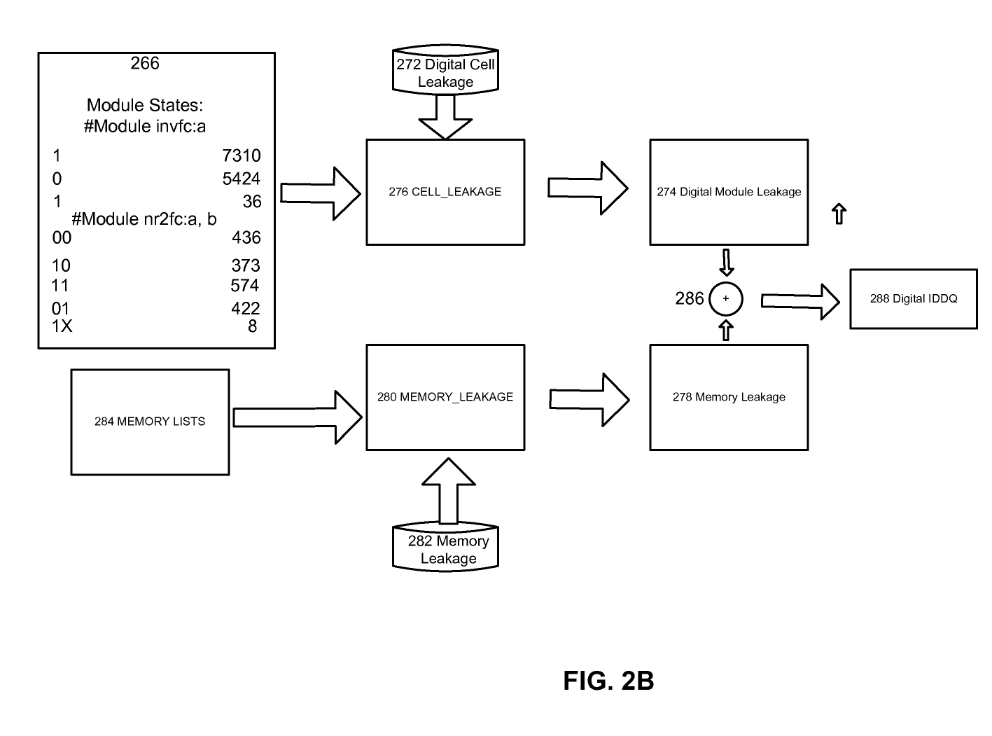

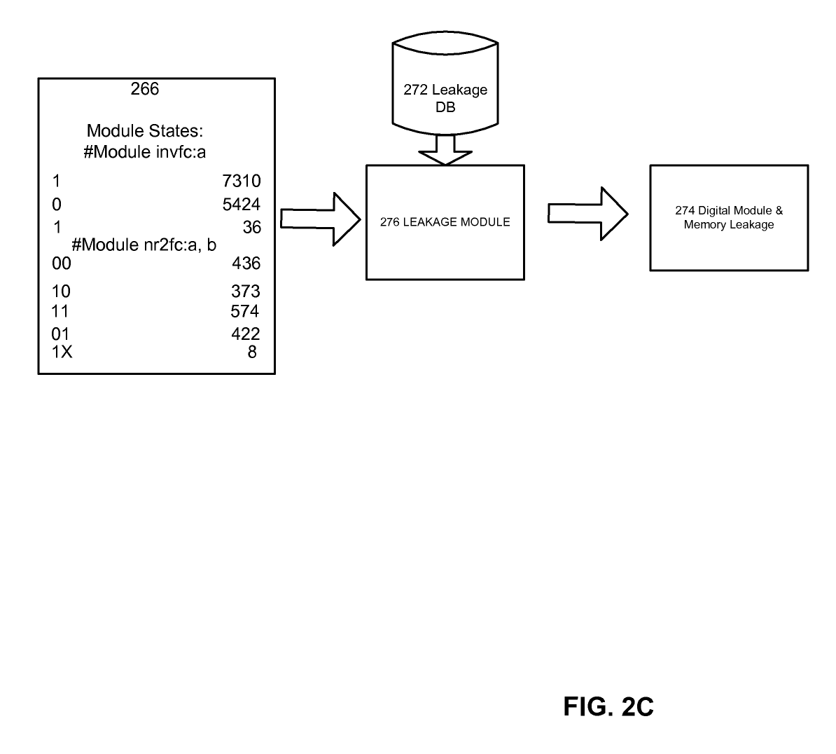

FIG. 2A illustrates selected aspects of I_{DDQ} vector analysis process flow 200, resulting in pattern verification and I_{DDQ} estimation and analysis. It is beneficial for I_{DDQ} verification to catch as many problems as possible prior to silicon arrival. The earlier potential issues are caught, the lower the diagnostic and symptomatic costs for first silicon bring-up, test development, and yield improvement. In the process flow 200, I_{DDQ} vectors 252 are first simulated on a simulator (e.g., a virtual tester or VT) 256, to determine the state of each node in the circuit at the end of the vectors 252 when the I_{DDQ} measurement is taken. The circuit state (states of the nodes) is saved into a storage (e.g., a value change dump or VCD file) 258. A design netlist 260 is processed to get a list of all primitive instances with their module names, and of all modules with input and output information, designated by numeral 262. The VCD files 258, containing circuit state as configured by specific I_{DDQ} vectors 252, are processed in combination with design information by an IVA (I_{DDQ} Vector Analysis) engine 264, to break down circuit state by module. The IVA engine 264 generates a statistical list 266 of all modules, with the number of instances of each module, in specific input status. This information is then used by an I_{DDQ} prediction or estimation module 268 and a pattern verification module 270.

As shown in FIG. 2A, for example, the list 266 indicates that the circuit includes 7310 instances of an inverter module of the type “invfc” with its single input in logical state “1,” 5424 instances of the inverter module with input in logical state “0,” and 36 instances of the same inverter module with input in an unknown or undefined logical state “X.” The list 266 also shows the same information for a two-input NOR gate module nr2fc. Information for all other modules of the circuit is similarly available. Moreover, although the list 266 shows statistical module states, states of the individual instances/primitives are also available. Note that this information can be used to estimate leakage current through each of the modules, because leakage for each type of module is known for each of the module's states. Information on all the cells is available, so that state of any pin can be checked directly. Whenever a special cell (e.g., an analog cell, a mixed digital-analog cell, or another cell with high current consumption and/or a wide range of current consumption), is found, its power mode state can be determined.

FIG. 2B illustrates a process flow of I_{DDQ} estimation of module 268 for a digital domain containing selected cells and memories. In FIG. 2B, leakage information of cells (e.g., cells included in the list 266) with a given input state can be read from a digital cell leakage database 272, which contains power library files. In a given block or power domain, the total leakage of all cells (digital module leakage) 274 can be estimated by aggregating the leakage of all instances by a cell leakage component 276 to correspond to the module states in the list 266.

Static random access memories (SRAM) may be designed so that their leakage in quiescent state is substantially independent of the different input values; for example, static leakage level may vary less than 0.1% as a function of the input state. Leakage of a typical non-defective SRAM cell may also be independent of data background, because of the typical internal symmetry of static memory cells. In this scenario, memory leakage 278 can be calculated by accumulating default leakage in a memory leakage process 280, which is from a database 282 of memory leakage corresponding to all memory instances on a memory list 284 of the circuit. Adding the leakage of memories 278 and the leakage of standard cells and other custom cells 274 in a summer 286 in the digital power domain results in an estimate of digital I_{DDQ} designated with reference numeral 288. It is not really necessary (but may be beneficial) to separate the memory leakage flow from the leakage flow of other digital cells. Therefore, in embodiments the databases 272 and 282 are combined, as are the cell leakage component 276 and the memory leakage process 280. This is illustrated in FIG. 2C.

I_{DDQ} estimation also adds value to vector verification. For a cell that requires a particular set of constraints to be put into a quiescent state, its constraint information is embedded within the leakage library file. That is, when the constraint requirements are met, the cell's leakage is relatively low; otherwise, it is significantly higher. The same may be true with PM setup, i.e., corresponding to specific PM setup for a given cell, the leakage level is determined. Typically, the elevation (as that term is described below) of the leakage current of the cell is reduced with the addition of PM setup information. Therefore, as with a virtual I_{DDQ} test, the estimates can be examined to determine if there is any potential vector generation problem.

For verification purposes, input conditions, particularly those of complex or custom cells, may be inspected on a per-cell basis, to ensure that all cells are properly constrained to a quiescent state and programmed into their required power mode. With cell constraint and PM setup information embedded in the leakage libraries, vector verification can be automated; for example, abnormally high estimates may be automatically recognized as indicating pattern generation problems; additional constraints and PM setup information can then be added, in response to the abnormally high estimates.

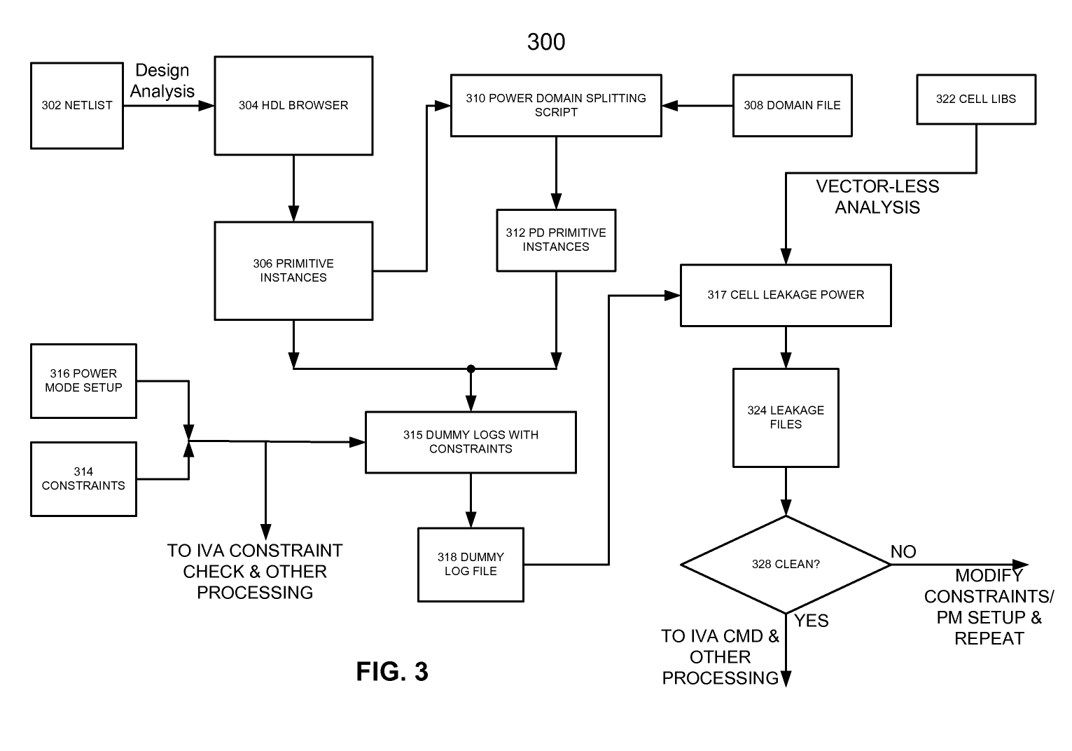

FIG. 3 illustrates selected aspects of IVA work flow 300. Starting with a netlist file 302, design analysis is performed using a hardware definition browser 304, to generate a list 306 of all primitive instances for the circuit. A domain file 308 describing different power domains may also be generated. A script or program 310 is then executed to split the complete list of primitive instances into different power domain primitive instances files 312. Each of the files 312 may correspond to a different power domain of the circuit.

Known constraints file 314 and power mode (PM) setup file 316 are combined with the information in the power domain primitive instances files 312 to generate a log file 318, in which all states, except those defined by the constraints and the PM setup in the files 314/316, are unknown/undefined. An example of a log file is illustrated in FIG. 2A, as the list 266. (Typically, mostly Xs rather than 0's and 1's would appear in the file, at least initially.)

The constraints file 314 describes/defines the I_{DDQ} vector states that guarantee that the cells with widest range between the lower and upper bounds of cell leakage are in a low power mode state, such as the “sleep” state. For example, a constraint may set an analog cell such a phase lock loop (PLL) to be in a sleep mode, to minimize the range of the cell's leakage; otherwise, the range of the PLL cell's leakage may be larger than variation in circuit leakage due to design flaws or manufacturing defects. Similarly, the PM setup file 316 sets the power mode of cells with relatively high current draw, to keep the circuit's total power consumption range narrow for a given power mode during I_{DDQ} testing. Generally, whether a cell is subject to a constraint or PM setup is determined by a property of the cell. Such properties may be stored in a properties file or elsewhere, and be available to the IVA work flow 300. Alternatively, this part of the process may receive manual input on a per-cell basis, differentiating between addition of constraints and PM setup definition.

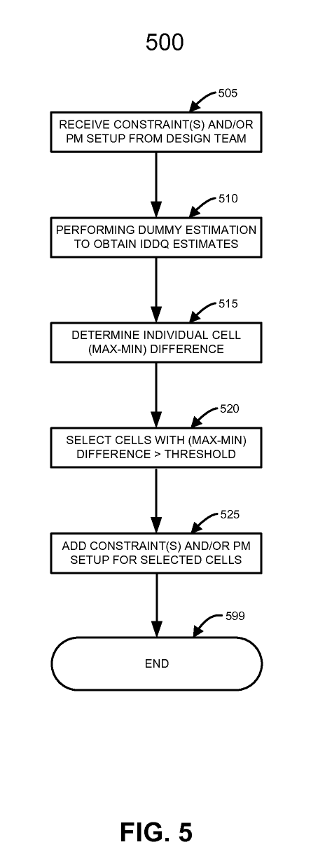

In examples, the initial information in the constraints file 314 and the PM setup file 316 may be provided by a design team and/or I_{DDQ} test team. The initial information in the files 314 and 316 may be verified, but this is not a requirement. Indeed, either file or both files may initially be empty. In examples, all or a portion of the initial information in the constraint file 314 and the PM setup file 316 is determined through a process described below in relation to FIG. 5. As will be described below, information is added to the constraints file 314 and the PM setup file 318 in the course of the IVA work flow.

Vector-less analysis is performed on leakage cell libraries 322 and the resulting information is combined with the log file 318 to obtain leakage files 324.

The cell libraries 322 can be leakage lookup tables; given a cell name and its input state or states, the cell's leakage power corresponding to each valid power rail under given temperature and power rail voltage can be looked up. As will be discussed below, special techniques to calculate leakage estimation are used. Possible range of the leakage estimates may be quite wide.

In decision block 328, a determination is made whether the constraint data in the file 314 and the PM setup data in the file 316 were correct and sufficient. If not, incorrect constraints and PM setup data will be corrected and/or additional constraint and/or PM setup data are added, as will be described below. For example, the decision block 328 may examine the range and the elevation of the individual cells, and result in a decision that the constraint and PM setup data are correct and sufficient if the range of each individual cell is less than a predetermined range limit and the elevation of each individual cell is less than a predetermined elevation limit. The decision block may result in a negative decision if (1) a first predetermined number of the individual cells with the highest ranges and/or a second predetermined number of the individual cells with the highest elevations contain custom cells, macros, or standard cells or memories with local power controls, that can be further controlled to yield lower ranges and/or better controlled elevations.

Table 1 below shows the current leakage estimates of a 3-input cell for various values of its input ports a, b, and c: for inputs 001, the cell's leakage is value_{—}1; for inputs 101, the cell's leakage is value_{—}2; for inputs 000, the cell's leakage is MIN, which is the absolute minimum (lowest) leakage of the cell; for inputs 111, the cell's leakage is MAX, which is the absolute maximum (highest) leakage of the cell; for all other input states, the leakage is approximated as def_value (default value). Note that MIN need not correspond to input state 000, and MAX need not correspond to 111. Similar tables may be available for other cells, with fewer or more than three inputs. The leakage value entries in such tables may be determined, for example, by computer modeling of the cells, and/or empirically.

TABLE 1

| | Input Ports: | | | | |
|---|---|---|---|---|---|
| | a, b, c | a, b, c | a, b, c | a, b, c | a, b, c |
| Input | 0, 0, 0 | 0, 0, 1 | 1, 0, 1 | 1, 1, 1 | all other |
| | | | | | (#default) |
| | absolute | value_1 | value_2 | absolute | def_value |
| | minimum | | | maximum | |
| | (MIN) | | | (MAX) | |

Table 2 below illustrates examples of the combined leakage estimates for the same 3-input cell, based on the information from the table 1. For the (a, b, c) inputs in the state (1, 0, 0), table 1 produces a def_value estimate, because there is no exact match to one of the non-default values. Therefore, the estimate obtained from the table 1 is def_value. The corresponding entry in the hits column shows “0/1” or zero out of one hits; this is so because there is a total of one possible exact match of the input states to the non-default value (because all inputs are defined, with no X's in the input state, thus limiting the universe of the possible hits to one out of eight); the actual match is instead to a default value (not an exact match); thus, there are zero matches or hits out of possible one hit. For the (a, b, c) inputs in state 001, there is an exact match in the table 1: value_{—}1. In this case, there is one “hit” (due to the exact match) out of possible one hit (again, all inputs are defined, so there is a potential single hit or match out of the universe of eight hits). For the input state 1X1, there are two exact hits: value_{—}2 corresponding to 101, and MAX corresponding to 111. Because X (undefined/unknown) is found in a single input state position, there are a total of two possible hits: one for 0 in the X position, the other for 1 in the same position, so the hits column shows 2/2, or two out of two. The leakage estimate is the arithmetic average of the two possibilities, or ((value_{—}2+MAX)/2). For the X0X inputs, there are four possible hits (because of the X's in two positions). Of the four possible hits, only three are realized, i.e., exactly matched in the table 1: 000 corresponding to MIN, 001 corresponding to value_{—}1, and 101 corresponding to value_{—}2. Thus, there are “3/4” or three out four hits. Taking the arithmetic average for the four possibilities and using def_value as the default value for the input state 100, the actual leakage estimate is expressed as ((MIN+value_{—}1+value_{—}2+def_value)/4).

TABLE 2

| | | | Lower | Estimate | Upper |
|---|---|---|---|---|---|
| Input | Matches | Hits | Bound | (Probable Estimate) | Bound |
| 100 | default | 0/1 | MIN | def_value | MAX |
| 001 | value_1 | 1/1 | value_1 | value_1 | value_1 |
| 1X1 | value_2, | 2/2 | value_2 | (value_2 + MAX)/2 | MAX |
| | MAX | | | | |
| X0X | MIN, | 3/4 | MIN | (MIN + value_1 + | MAX |
| | value_1, | | | value_2 + | |
| | value_2, | | | def_value)/4 | |
| | default | | | | |

Turning next to the lower bound (LB) and upper bound (UB) columns, the lowest and the highest leakage estimates, respectively, appear in each of these columns for the input states. Note that there may be some uncertainty in the estimate for the input states when there is more than a single estimate or a def_value estimate for the input states. In the case of the (a, b, c) inputs in the 100 state, the estimate is def_value, which may fall between the MIN and MAX values. The LB and the UB are thus MIN and MAX, respectively. When the (a, b, c) inputs are in the 001 state, the estimate is an exact match, value_{—}1, which becomes both the LB and the UB (no uncertainty for an exact hit out of possible one hit). For the (a, b, c) inputs in the 1X1 states, there are two actual possibilities: the leakage is either value_{—}2 when the inputs are 101, or MAX when the inputs are 111. Because value_{—}2 is no greater than MAX (by definition of MAX), the LB is value_{—}2, and the UB is MAX. For the XOX inputs, it is easy to see that the LB is MIN, the lowest possible value corresponding to the inputs in 000 state. Because the def_value must also be considered (100 inputs), the UB becomes MAX, which is no less than the default value, by definition. For input state (0, 0, 1), the leakage is value_{—}1; for input state (1, 0, 1), the leakage is value_{—}2; in either case, the leakage value is not less than LB and not greater than UB.

Elevation for each of the cells is the difference between the actual estimate of I_{DDQ} (fifth column from the left in Table 2) and MIN for the cell.

We now define the following concepts applicable to a given power domain of the circuit:

(1) UB for the circuit is the aggregate of UB values for the cells of the circuit, in the given power domain;
(2) LB for the circuit is the aggregate of LB values for the cells of the circuit, in the given power domain;
(3) Actual leakage estimate for the circuit is the he aggregate of the actual leakage estimates for the cells of the circuit, in the given power domain;
(4) Leakage “range” or “gap” for the circuit is (UB-LB), or the difference between the UB and the LB for the circuit, in the given power domain;
(5) MIN for the circuit is the aggregate of MIN values for the cells of the circuit, in the given power domain;
(6) MAX for the circuit is the aggregate of MAX values for the cells of the circuit, in the given power domain; and
(7) Elevation for the circuit is the difference between the actual estimate for the circuit and MIN for the circuit, in the given power domain.

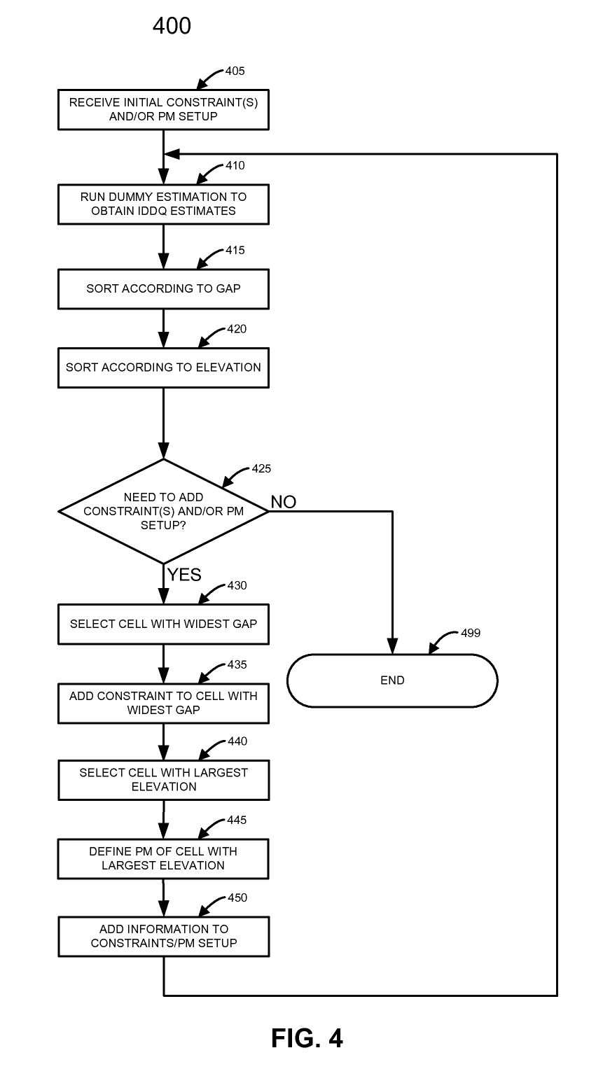

In attempting to define constraints and PM setup, we try to decrease the range, and the elevation of the circuit. FIG. 4 illustrates selected steps and decision of a process 400 for automating the determination of constraints and PM setup.

In step 405, initial constraints and PM setup files are received. As noted above, either or both files may contain no information, or may not be received.

In step 410, estimation is run to obtain I_{DDQ} estimates including MIN, LB, actual estimate, UB, and MAX, for each cell of the circuit, under the assumption of the stimulus provided by the vectors.

In step 415, the cells of the circuit are sorted in the order of their range values (UB less LB for each of the cells), to obtain a range-sorted list of cells.

In step 420, the cells of the circuit are sorted in the order of the cells' elevation values (actual estimate less LB for each of the cells), to obtain an elevation-sorted list of cells.

A decision is made in decision block 425 whether a need exists to add to the constraints and/or PM setup files. For example, the decision block may examine the range and/or the elevation of the individual cells, and result in a negative decision if (1) the range of each individual cell is less than a predetermined range limit, and/or (2) the elevation of each individual cell is less than a predetermined elevation limit. The decision block may also result in a negative decision if a first predetermined number of the individual cells with the highest range values and a second predetermined number (which may, but need not, be the same as the first number) of the individual cells with the highest elevation values contain custom cells, macros, or standard logical cells or memories with local power controls, that can be further programmed to yield lower ranges and/or better controlled elevations. A macro is generally a functionally related large block, in which block the subcells are not analyzed individually; it is generally treated as a “black box” with I_{DDQ} leakage and I/O functionality defined for the entire macro. As another example, the decision block 425 may result in a negative decision if the aggregate gap of the circuit is below a predetermined circuit gap limit, and the aggregate elevation of the circuit is below a predetermined circuit elevation limit.

When the decision is negative, process flow terminates in flow point 499. Otherwise, the process flow proceeds to step 430.

In the step 430, the cell(s) with the largest ranges are selected. In embodiments, two or more cells with range larger than all other cells are selected. In embodiments, all cells whose range exceeds the predetermined range limit are selected.

In step 435, at least one constraint is added so that the power mode of the cell (or cells) selected in the step 430 is defined to be the lowest power mode available for the selected cell(s). For example, a constraint is added to put the cell or cells with the highest range into a sleep mode in which the cell is essentially not powered. This has the effect of reducing the range of the selected cell to zero.

In step 440, the cell with the largest elevation is selected. In embodiments, two or more cells with elevation larger than all other cells are selected. In embodiments, all cells whose elevation exceeds the predetermined elevation limit are selected.

In step 445, at least one PM selection is added so that the power mode of the cell (or cells) selected in the step 440 is defined.

In step 450, power mode information from the step 445 is added to the PM setup file, and/or constraint information from the step 435 is added to the constraints file, so that the power mode of the cells selected in the steps 430/440 is defined. The choice between adding a constraint or defining PM for a particular cell may be made based on an associated property of the cells. As noted above, the cell information may include such property for each of the cell types. For example, the property may indicate that all analog and mixed analog-digital cells must be constrained, while standard digital cells be subjected to PM definition. The choice for each of the cells selected in the step 440 may also be received through manual entry.

Process flow then returns to the step 410 and the steps are repeated with the added constraint and/or PM setup information.

In variants, the decision in the decision block 425 may be negative in relation to the need to add to constraints, and at the same time, the decision in the block 425 may be positive in relation to the need to add to the PM setup information. In variants, the decision in the decision block 425 may be positive in relation to the need to add to constraints, and at the same time, the decision in the block 425 may be positive in relation to the need to add to the PM setup information. When only one of these two decisions is positive, the process 400 may be continued with the subsequent iterations omitting either the steps 415/430/435 (in the case when there is no need to decrease the gap), or the steps 420/440/445 (in the case when there is no need to decrease the elevation. In variants, however, both sets of steps 415/430/435 and 420/440/445 are performed in each of the iterations even if it is determined that a need to reduce the gap or the need to reduce the elevation is not present (but at least one of these needs is present).

FIG. 5 illustrates selected steps and decision of a process 500 for automating the determination of all or a portion of the initial information in the constraint file 314 and the PM setup file 316. As has already been mentioned, either or both files may contain no information when the process 400 is executed. There may, however, be an advantage in providing some of the information before initiating the process 400. All or part of that information may be provided by the design team, and all or part of the information may be determined in accordance with the process 500. As an overview, the process 500 is analogous to portions of the process 400, with the imposition of constraints and/or PM setup being done in the order of (MAX−MIN) difference of the cells.

In step 505, the constraints and PM setup files receive information provided by the design team for the parceled device. Again, this is optional; the design team may or may not provide some information.

In step 510, estimation is performed to obtain I_{DDQ} estimates, for example, including MIN and MAX for each cell of the power domain, at all power rails. This step is similar but not necessarily identical to the step 410 of the process 400; for example, LB, actual estimate, and UB may or may not be obtained.

In step 515, maximum MAX/MIN difference values are computed for each of the cells across all the power rails, i.e., the maximum magnitudes of their respective values of (MAX−MIN) across all the power rails.

In the step 520, the cells with the maximum MAX/MIN differences in excess of a predetermined MAX/MIN difference threshold (for example, 1 Microwatt) are selected.

In step 525, constraint(s) and/or PM selection(s) are added to the selected cells. Note that there may be no selected cells in the step 520, in which case there would be no need to add constraints or PM selections in the step 525.

The process 500 may then terminate in a flow point 599.

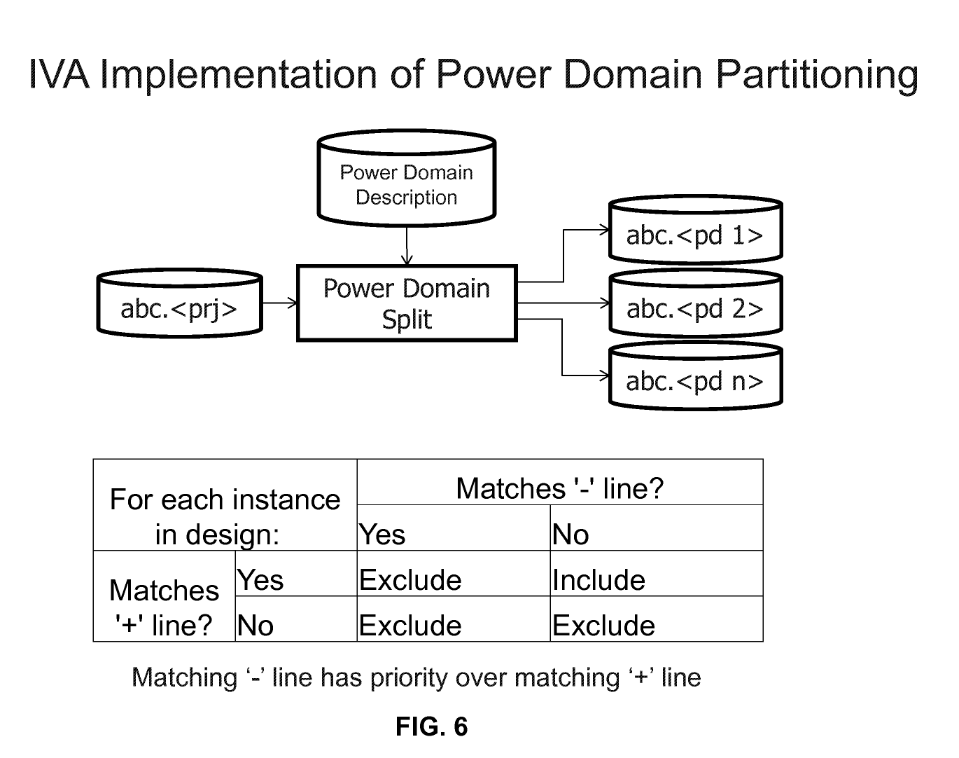

FIGS. 6-8 illustrate selected aspects of a format for power domain description and partitioning.

The concept of “power domain” partitioning refers to the way power supply lines connect to the cells within a chip/circuit. A particular power domain is essentially a power supply line that feeds the cells within that domain. Supply current, including I_{DDQ}, can be measured separately for each power domain. There may be two or more power domains for the same power supply voltage, such as digital V_{DD}. Alternatively, there may be a single power domain for a particular power supply voltage. The concept of power domains is known in integrated circuit design.

Methods and systems for I_{DDQ} vector analysis (IVA) and other design flows use power domain descriptions of the tested circuits.

Unified Power Format (UPF) is a known standard that can be used to specify power domains. A draft of this standard is available at http://www.accellera.org/apps/group_public/documents.php?wg_abbrev=upf. Common Power Format (CPF) is a file format that can also be used for to specify power domains. The UPF and CPF formats are similar. Under each of these standards, a scope may be defined, and then instances may be defined and added to the domain separately. Here is an example definition in UPF: create_power_domain domain_name [-elements list] [-include_scope] [-scope instance_name]. And here is an example definition in CPF: create_power_domain -name power_domain {-default [-instances instance_list] . . . .

UPF and CPF are similar and have similar limitations in that they do not have the features of including or excluding certain sub-elements from a conveniently defined list of elements, or the feature of including or excluding elements by cell type within a given scope. Taking the case delineated in the SUMMARY above, when UPF is used to describe GDFS domain, a separate MEMORY domain may also need to be defined as consisting of all the memories within the GDFS domain, and their power supply, power calculation, etc., must be addressed separately. However, listing separate memory or other instances is a labor-intensive process, susceptible to errors, especially when a large number of instances may need to be entered manually, and the list may need to be maintained across different versions of the design netlist sets through the design flow. In sum, using UPF or CPF it is hard to describe complex domains so that all instances are POWER AWARE in a straightforward way. However, IVA flows need to determine to which domain each instance belongs. Similarly, this knowledge may be necessary in modeling and simulation.

To facilitate power domain definitions, we propose the following format:

domain <domain_name>:(+|−)(hier|module) (reg expr | plain text)

(+|−)(hier|module) (reg expr | plain text)

......

We refer to this as the “IVA format” for power domain definitions, with each domain description line taking the form of (+|−)(hier|module) (reg expr|plain text). Note that the memory modules can be specified as types of cells, and memory cell name follow certain unique conventions, so that all memory cells can be included or excluded with relative ease. A power domain may thus be described in the IVA format using three parts: name of the block(s), minus modules RAM, minus modules ROM (since usually RAM and ROM cells follow slightly different naming conventions). Here is an example of such memory definition lines, which are excluded from the domain: -module:qcsram.*, -module:qcrom.*. Note that in this definition the memories are specified as types of cells; thus, the modules with the name qcsram.* and qcrom.* are excluded from the power domain. There is no need to separately specify each instance of the memory that typically does not belong to the domain.

Some variants of this format may also help improve the efficiency of power domain description. For example, the syntax (+|−)<scope><module> may also be used, where <scope> and <module> may be in plain text format, or regular expression, and the <scope> can be predefined scope consisting of different elements. Second, domain calculation can be introduced using the form (+|−(domain|macro)(reg expr|plain text), where either predefined domain or macro can be referred to and either added or excluded from current domain, and such domain or macro may either assume the form of plain text, or regular expression.

Here is another example of a definition in the IVA format: domain <domain_name>:(+|−)<scope|hier_instance><cell>, where aegular expression can be used for instance/cell names. Here are some more examples:

domain pd_wmac : + /u_wmac_sys .*

− /u_wmac_sys/u_wmac_sys_aon_wrap .*

Regular expression for qcsram model can be written thus:

\hat{ }qcsram[\d]{4}_\d+x\d+_\d+

matches “qcsram2111_1024x16_4”; or thus

domain pd_wmac_ka : + /u_wmac_sys/u_wmac_sys_aon_wrap .*

domain pd_wmac : + /u_wmac_sys .*

− pd_wmac_ka

The IVA format for power domain definition can be advantageously used to estimate leakage currents correctly for some or all power domains, and to run power controlled simulations with some or all instances being power aware. The IVA format may also be used to run concurrent tests. (As long as the resources needed for each test are available; note that in this case powering down of some circuits may be required, and the powered down circuits will become unavailable.)

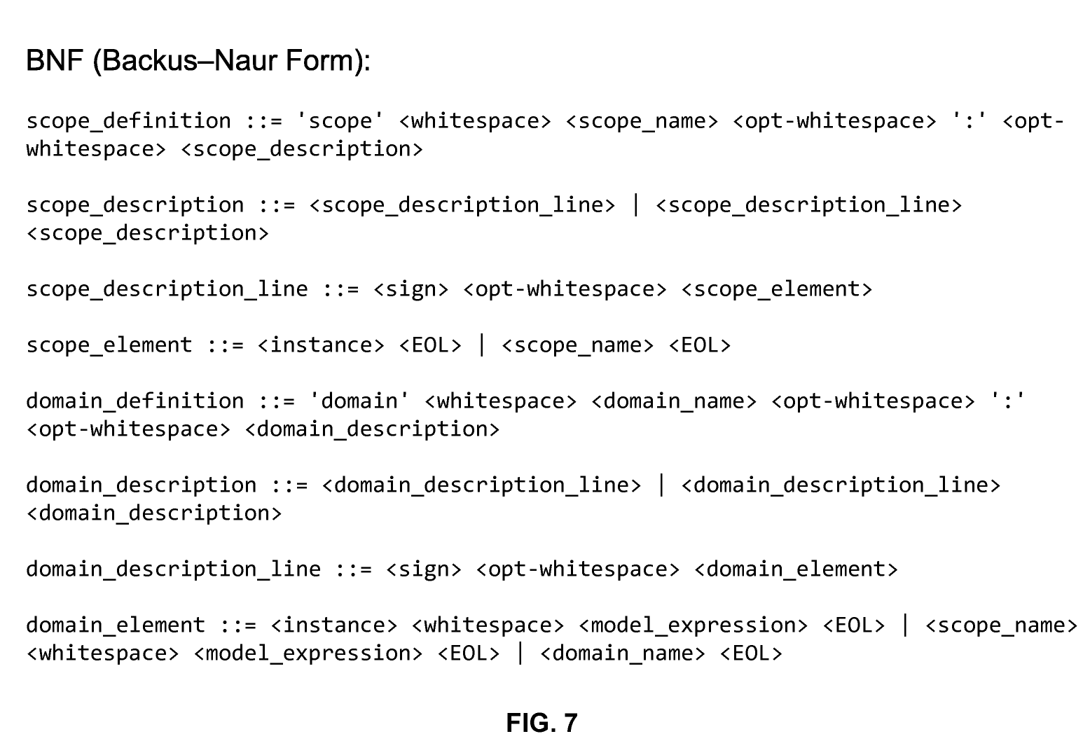

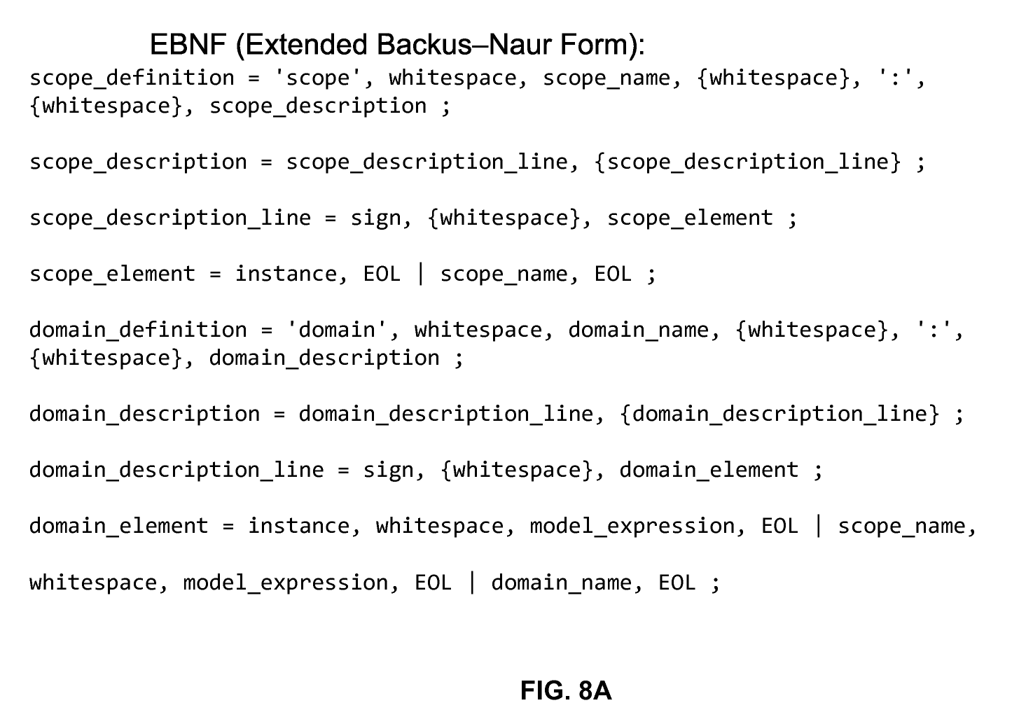

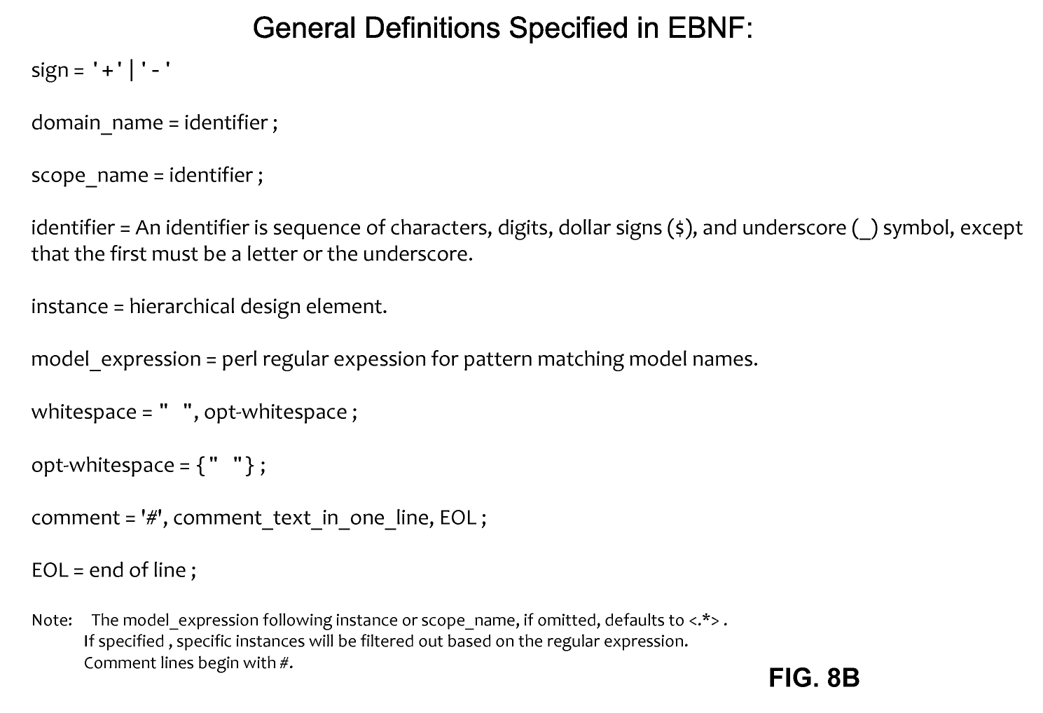

FIGS. 7, 8A, and 8B show examples of IVA format definitions in Backus-Naur Form (BNF) and in Extended Backus-Naur Form (EBNF).

The power domain definitions in accordance with this disclosure may be stored in machine-readable media and transmitted over networks, for example. The definitions may be used in placing and routing integrated circuits, modeling/simulating integrated circuits, I_{DDQ} testing of integrated circuits (before or after silicon), and for other design purposes. In particular, the IVA format, as defined above, may be used for running dummy estimation (to obtain I_{DDQ} estimates) in variants of the processes for automating the determination of constraints and PM setup described in this document.

Although steps and decision blocks of various methods may have been described serially in this disclosure, some of these steps and decisions may be performed by separate elements in conjunction or in parallel, asynchronously or synchronously, in a pipelined manner, or otherwise. There is no particular requirement that the steps and decisions be performed in the same order in which this description lists them and the accompanying Figures show them, except where explicitly so indicated, otherwise made clear from the context, or inherently required. It should be noted, however, that in selected variants the steps and decisions are performed in the particular progressions described above and/or shown in the accompanying Figures. Furthermore, not every illustrated step and decision may be required in every system, while some steps and decisions that have not been specifically illustrated may be desirable in some embodiments.

Those of skill in the art would understand, after perusal of this document, that the same analysis is also applicable to other static or dynamic leakage tests, based on corresponding cell leakage information; it need not necessarily be limited to quiescent current tests.

Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a terminal. In the alternative, the processor and the storage medium may reside as discrete components in a terminal.

It should be appreciated that semiconductor manufacturing with silicon substrates has been described herein as illustrative implementations. Aspects consistent with the present disclosure have application to other semiconductors such as gallium arsenide.

In view of the exemplary systems described above, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not necessarily limited by the order of the blocks, as some blocks may occur in different orders or concurrently with other blocks from what is depicted and described herein. Moreover, not all illustrated blocks may be required to implement the methodologies described herein. Additionally, it should be appreciated that the methodologies disclosed herein are capable of being stored on an article of manufacture, for example, to facilitate transporting and transferring such methodologies to computers. The term article of manufacture, as used herein, is intended to encompass a computer program accessible from a computer-readable device, carrier, or media.

The previous description of the disclosed embodiments and variants is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments and variants shown herein, but is to be accorded the widest scope consistent with the principles and novel features disclosed herein.

Therefore, the present invention is not to be limited except in accordance with the claims.

What is claimed is:

1. A method of determining power state control information for quiescent power supply (I_{DDQ}) testing of a circuit, the method comprising performing by a computing system steps of:
running a first estimation to obtain I_{DDQ} estimates, the I_{DDQ} estimates comprising, for each cell of a power domain of the circuit, an absolute minimum estimate (MIN), a lower bound estimate (LB), a probable estimate, and an upper bound estimate (UB), the step of running an estimation using a current constraint information and a current power mode (PM) setup information;
identifying one or more first cells of the predetermined domain with highest gap values, a gap value of a cell being a difference between UB and LB for the cell;
determining whether a need exists to add to current constraint information based on one or more predetermined constraint criteria, the one or more predetermined constraint criteria being based on the highest gap values;
in response to existence of the need to add to the current constraint information, adding one or more constraints to the current constraint information;
first repeating the steps of running, identifying one or more first cells, determining whether the need exists to add to current constraint information, and, in response to the existence of the need to add to current constraint information, adding one or more constraints to the current constraint information; and
performing I_{DDQ} testing on the circuit in response to non-existence of the need to add to the current constraint information.

2. A method according to claim 1, further comprising:
identifying one or more second cells of the predetermined domain with highest elevation values, an elevation value of a cell corresponding to a difference between probable estimate of the cell and MIN of the cell;
determining whether a need exists to add to current PM setup information based on one or more predetermined PM setup criteria, the one or more predetermined PM setup criteria being based on the highest elevation values; and
in response to the existence of the need to add to current PM setup information, adding one or more PM setup values to the current PM setup information; and
second repeating the steps of identifying one or more second cells, determining whether the need exists to add to current PM setup information, and, in response to the existence of the need to add to current PM setup information, adding one or more PM setup values to the current PM setup information;
wherein the step of performing I_{DDQ} testing is performed in response to (1) non-existence of the need to add to the current constraint information, and (2) non-existence of the need to add to the current PM setup information.

3. A method according to claim 2, further comprising:
running a second estimation to obtain, for each cell of the power domain, the MIN and an absolute maximum estimate (MAX) of I_{DDQ} of all power rails;
determining, for said each cell of the power domain, (MAX−MIN) difference for all power rails;
selecting from the cells of the power domain cells with the maximum (MAX−MIN) difference across all power rails greater than a predetermined threshold;
adding an initial constraint to the current constraint information or an initial PM setup value to the current PM setup information, for each of the cells with (MAX−MIN) difference greater than the predetermined threshold;
wherein the steps of running a second estimation, determining (MAX−MIN) difference, selecting, and adding an initial constraint or an initial PM setup value are performed before the steps of running a first estimation, identifying, and determining whether a need exists.

4. A method according to claim 2, wherein the step of identifying one or more first cells comprises sorting the cells of the power domain of the circuit in an order of elevation values.

5. A method according to claim 2, wherein the step of identifying one or more second cells comprises sorting the cells of the power domain of the circuit in an order of elevation values.

6. A method according to claim 5, wherein the step of identifying one or more first cells comprises sorting the cells power domain of the circuit in an order of elevation values.

7. A method according to claim 2, wherein the one or more first cells consist of a single first cell, and the one or more second cells consist of a single second cell.

8. A method according to claim 2, wherein the one or more first cells comprise at least two first cells, and the one or more second cells comprise at least two second cells.

9. A method according to claim 2, wherein the step of determining whether a need exists to add to current constraint information comprises comparing gap value of each of the first cells to a predetermined gap limit, and the need to add to the current constraint information does not exist if gap value of each of the first cells does not exceed the predetermined gap limit.

10. A method according to claim 2, wherein the step of determining whether a need exists to add to current PM setup information comprises comparing elevation value of each of the second cells to a predetermined elevation limit, and the need to add to the current PM setup information does not exist if elevation value of each of the second cells does not exceed the predetermined elevation limit.

11. A method according to claim 2, wherein the step of determining whether a need exists to add to current constraint information comprises comparing an aggregate gap value of the power domain of the circuit to a predetermined circuit gap limit, and the need to add to current constraint information does not exist if the aggregate gap value of the power domain of the circuit does not exceed the predetermined circuit gap limit, the aggregate gap values of the power domain of the circuit being a sum of individual gap values of the cells of the power domain of the circuit.

12. A method according to claim 2, wherein the step of determining whether a need exists to add to current PM setup information comprises comparing aggregate elevation of the power domain of the circuit to a predetermined circuit elevation limit, and the need to add to current PM setup information does not exist if the aggregate elevation of the power domain of the circuit does not exceed the predetermined circuit elevation limit, the aggregate elevation of the power domain of the circuit being a sum of individual elevation values of the cells of the power domain of the circuit.

13. A method according to claim 2, wherein the step of adding one or more constraints comprises adding the one or more constraints to put the one or more first cells with the highest gap values into a sleep mode.

14. A method according to claim 13, wherein the step of adding one or more PM setup values to the current PM setup information comprises adding the one or more PM setup values to define power mode for each cell of the one or more second cells with the highest elevation values.

15. A method according to claim 2, wherein the step of determining whether a need exists to add to current constraint information comprises determining that the need to add to the current constraint information does not exist in response to each cell of the one or more first cells with the highest gap values being a custom cell, a macro cell, a standard logical cell, or a memory with local power control.

16. A method according to claim 15, wherein the step of determining whether a need exists to add to current PM setup information comprises determining that the need to add to the current constraint information does not exist in response to each cell of the one or more second cells with the highest elevation values being a custom cell, a macro cell, a standard logical cell, or a memory with local power control.

17. A method according to claim 2, wherein the circuit is an integrated semiconductor circuit and the step of performing I_{DDQ} testing comprises measuring actual I_{DDQ} of the circuit.

18. A method according to claim 2, wherein the I_{DDQ} estimates further comprise, for each cell of the power domain of the circuit, an absolute maximum estimate (MAX).

19. A method according to claim 2, wherein the step of running a first estimation comprises determining cells of the power domain from an IVA (I_{DDQ} Vector Analysis) format definition of the power domain.

20. An article of manufacture comprising at least one machine readable medium storing instructions for configuring a computing system to perform steps of a method of determining power state control information for quiescent power supply (I_{DDQ}) testing of a circuit, the method comprising:
running an estimation to obtain I_{DDQ} estimates, the I_{DDQ} estimates comprising, for each cell of a power domain of the circuit, an absolute minimum estimate (MIN), a lower bound estimate (LB), a probable estimate, and an upper bound estimate (UB), the step of running an estimation using a current constraint information and a current power mode (PM) setup information;
identifying one or more first cells of the predetermined domain with highest gap values, a gap value of a cell being a difference between UB and LB for the cell;
determining whether a need exists to add to current constraint information based on one or more predetermined constraint criteria, the one or more predetermined constraint criteria being based on the highest gap values;
in response to existence of the need to add to the current constraint information, adding one or more constraints to the current constraint information;
first repeating the steps of running, identifying one or more first cells, determining whether the need exists to add to current constraint information, and, in response to the existence of the need to add to current constraint information, adding one or more constraints to the current constraint information; and
performing I_{DDQ} testing on the circuit in response to non-existence of the need to add to the current constraint information.

21. An article of manufacture according to claim 20, wherein the steps further comprise:
identifying one or more second cells of the predetermined domain with highest elevation values, an elevation value of a cell corresponding to a difference between probable estimate of the cell and MIN of the cell;
determining whether a need exists to add to current PM setup information based on one or more predetermined PM setup criteria, the one or more predetermined PM setup criteria being based on the highest elevation values; and
in response to the existence of the need to add to current PM setup information, adding one or more PM setup values to the current PM setup information; and
second repeating the steps of identifying one or more second cells, determining whether the need exists to add to current PM setup information, and, in response to the existence of the need to add to current PM setup information, adding one or more PM setup values to the current PM setup information;
wherein the step of performing I_{DDQ} testing is performed in response to (1) non-existence of the need to add to the current constraint information, and (2) non-existence of the need to add to the current PM setup information.

22. An article of manufacture according to claim 21, wherein the step of determining whether a need exists to add to current constraint information comprises comparing gap value of each of the first cells to a predetermined gap limit, and the need to add to the current constraint information does not exist if gap value of each of the first cells does not exceed the predetermined gap limit.

23. An article of manufacture according to claim 20, wherein the method further comprises:
running a second estimation to obtain, for each cell of the power domain, the MIN and an absolute maximum estimate (MAX) of I_{DDQ} of all power rails;
determining, for said each cell of the power domain, (MAX−MIN) difference for all power rails;
selecting from the cells of the power domain cells with the maximum (MAX−MIN) difference across all power rails greater than a predetermined threshold;
adding an initial constraint to the current constraint information or an initial PM setup value to the current PM setup information, for each of the cells with (MAX−MIN) difference greater than the predetermined threshold;
wherein the steps of running a second estimation, determining (MAX−MIN) difference, selecting, and adding an initial constraint or an initial PM setup value are performed before the steps of running a first estimation, identifying, and determining whether a need exists.

24. A computing system comprising at least one processor and at least one memory storing instructions, wherein, when the instructions are executed by the at least one processor, the processor configures the computing system to perform a method for determining power state control information for quiescent power supply (I_{DDQ}) testing of a circuit, the method comprising:
running an estimation to obtain I_{DDQ} estimates, the I_{DDQ} estimates comprising, for each cell of a power domain of the circuit, an absolute minimum estimate (MIN), a lower bound estimate (LB), a probable estimate, and an upper bound estimate (UB), the step of running an estimation using a current constraint information and a current power mode (PM) setup information;
identifying one or more first cells of the predetermined domain with highest gap values, a gap value of a cell being a difference between UB and LB for the cell;
determining whether a need exists to add to current constraint information based on one or more predetermined constraint criteria, the one or more predetermined constraint criteria being based on the highest gap values;
in response to existence of the need to add to the current constraint information, adding one or more constraints to the current constraint information; and
first repeating the steps of running, identifying one or more first cells, determining whether the need exists to add to current constraint information, and, in response to the existence of the need to add to current constraint information, adding one or more constraints to the current constraint information.

25. A computing system according to claim 24, wherein the method further comprises:
identifying one or more second cells of the predetermined domain with highest elevation values, an elevation value of a cell corresponding to a difference between probable estimate of the cell and MIN of the cell;
determining whether a need exists to add to current PM setup information based on one or more predetermined PM setup criteria, the one or more predetermined PM setup criteria being based on the highest elevation values; and
in response to the existence of the need to add to current PM setup information, adding one or more PM setup values to the current PM setup information; and
second repeating the steps of identifying one or more second cells, determining whether the need exists to add to current PM setup information, and, in response to the existence of the need to add to current PM setup information, adding one or more PM setup values to the current PM setup information.

26. A computing system according to claim 24, wherein the step of identifying one or more first cells comprises sorting the cells of the power domain of the circuit in an order of elevation values.

27. A computing system according to claim 25, wherein the step of identifying one or more second cells comprises sorting the cells of the power domain of the circuit in an order of elevation values.

28. A computing system according to claim 27, wherein the step of identifying one or more first cells comprises sorting the cells power domain of the circuit in an order of elevation values.

29. A computing system according to claim 25, wherein the one or more first cells consist of a single first cell, and the one or more second cells consist of a single second cell.

30. A computing system according to claim 25, wherein the one or more first cells comprise at least two first cells, and the one or more second cells comprise at least two second cells.

31. A computing system according to claim 24, wherein the step of determining whether a need exists to add to current constraint information comprises comparing gap value of each of the first cells to a predetermined gap limit, and the need to add to the current constraint information does not exist if gap value of each of the first cells does not exceed the predetermined gap limit.

32. A computing system according to claim 25, wherein the step of determining whether a need exists to add to current PM setup information comprises comparing elevation value of each of the second cells to a predetermined elevation limit, and the need to add to the current PM setup information does not exist if elevation value of each of the second cells does not exceed the predetermined elevation limit.

33. A computing system according to claim 25, wherein the step of determining whether a need exists to add to current constraint information comprises comparing an aggregate gap value of the power domain of the circuit to a predetermined circuit gap limit, and the need to add to current constraint information does not exist if the aggregate gap value of the power domain of the circuit does not exceed the predetermined circuit gap limit, the aggregate gap values of the power domain of the circuit being a sum of individual gap values of the cells of the power domain of the circuit.

34. A computing system according to claim 25, wherein the step of determining whether a need exists to add to current PM setup information comprises comparing aggregate elevation of the power domain of the circuit to a predetermined circuit elevation limit, and the need to add to current PM setup information does not exist if the aggregate elevation of the power domain of the circuit does not exceed the predetermined circuit elevation limit, the aggregate elevation of the power domain of the circuit being a sum of individual elevation values of the cells of the power domain of the circuit.

35. A computing system according to claim 25, wherein the step of adding one or more constraints comprises adding the one or more constraints to put the one or more first cells with the highest gap values into a sleep mode.

36. A computing system according to claim 35, wherein the step of adding one or more PM setup values to the current PM setup information comprises adding the one or more PM setup values to define power mode for each cell of the one or more second cells with the highest elevation values.

37. A computing system according to claim 25, wherein the step of determining whether a need exists to add to current constraint information comprises determining that the need to add to the current constraint information does not exist in response to each cell of the one or more first cells with the highest gap values being a custom cell, a macro cell, a standard logical cell, or a memory with local power control.

38. A computing system according to claim 37, wherein the step of determining whether a need exists to add to current PM setup information comprises determining that the need to add to the current constraint information does not exist in response to each cell of the one or more second cells with the highest elevation values being a custom cell, a macro cell, a standard logical cell, or a memory with local power control.

39. A computing system according to claim 25, wherein the I_{DDQ} estimates further comprise, for each cell of the power domain of the circuit, an absolute maximum estimate (MAX),

40. A computing system according to claim 25, wherein the circuit is an integrated semiconductor circuit and the method further comprises performing I_{DDQ} testing on the circuit in response to (1) non-existence of the need to add to the current constraint information, and (2) non-existence of the need to add to the current PM setup information.

41. A computing system according to claim 25, wherein the circuit is virtual circuit and the method further comprises performing I_{DDQ} testing on the circuit using a virtual tester.

42. A computing system according to claim 25, wherein the step of running an estimation comprises determining cells of the power domain from an IVA (I_{DDQ} Vector Analysis) format definition of the power domain, wherein the IVA format definition of the power domain is stored in the at least one memory.

43. A computing system according to claim 25, wherein the method further comprises:
running a second estimation to obtain, for each cell of the power domain, the MIN and an absolute maximum estimate (MAX) of I_{DDQ} of all power rails;
determining, for said each cell of the power domain, (MAX−MIN) difference for all power rails;
selecting from the cells of the power domain cells with the maximum (MAX−MIN) difference of all power rails greater than a predetermined threshold;
adding an initial constraint to the current constraint information or an initial PM setup value to the current PM setup information, for each of the cells with (MAX−MIN) difference greater than the predetermined threshold;
wherein the steps of running a second estimation, determining (MAX−MIN) difference, selecting, and adding an initial constraint or an initial PM setup value are performed before the steps of running a first estimation, identifying, and determining whether a need exists.

44. A method of determining power state control information for quiescent power supply (I_{DDQ}) testing of a circuit, the method comprising performing by a computing system steps of:
step for obtaining I_{DDQ} estimates, the I_{DDQ} estimates comprising, for each cell of a power domain of the circuit, an absolute minimum estimate (MIN), a lower bound estimate (LB), a probable estimate, and an upper bound estimate (UB), the step of running an estimation using a current constraint information and a current power mode (PM) setup information;
step for identifying one or more first cells of the predetermined domain with highest gap values;
step for determining whether a need exists to add to current constraint information based on one or more predetermined constraint criteria, the one or more predetermined constraint criteria being based on the highest gap values;
in response to existence of the need to add to the current constraint information, step for adding one or more constraints to the current constraint information;
repeating the step for obtaining, step for identifying one or more first cells, step for determining whether the need exists to add to current constraint information, and, in response to the existence of the need to add to current constraint information, step for adding one or more constraints to the current constraint information; and
step for performing I_{DDQ} testing on the circuit in response to non-existence of the need to add to the current constraint information.

45. A method according to claim 44, further comprising:
step for identifying one or more second cells of the predetermined domain with highest elevation values, an elevation value of a cell corresponding to a difference between probable estimate of the cell and MIN of the cell;
step for determining whether a need exists to add to current PM setup information based on one or more predetermined PM setup criteria, the one or more predetermined PM setup criteria being based on the highest elevation values; and
in response to the existence of the need to add to current PM setup information, step for adding one or more PM setup values to the current PM setup information; and
repeating the step for identifying one or more second cells, step for determining whether the need exists to add to current PM setup information, and, in response to the existence of the need to add to current PM setup information, step for adding one or more PM setup values to the current PM setup information;
wherein the step for performing I_{DDQ} testing is performed in response to (1) non-existence of the need to add to the current constraint information, and (2) non-existence of the need to add to the current PM setup information.

46. A method of simulating an integrated circuit, the method comprising:
reading an I_{DDQ} Vector Analysis (IVA) format definition of at least one power domain of the integrated circuit;
simulating cells of the integrated circuit using the IVA format definition of at least one power domain of the integrated circuit; and
at least one of (1) displaying results of the step of simulating and (2) storing the results of the step of simulating.

47. A method of performing leakage current testing of an integrated circuit, the method comprising:
reading an I_{DDQ} Vector Analysis (IVA) format definition of at least one power domain of the integrated circuit;
driving the integrated circuit with predetermined vectors;
determining leakage current of cells of the integrated circuit using the IVA format definition of at least one power domain of the integrated circuit; and
at least one of (1) displaying results of the step of simulating and (2) storing the results of the step of simulating.

48. A computing system comprising at least one processor and at least one memory storing instructions, wherein, when the instructions are executed by the at least one processor, the processor configures the computing system to perform a method of simulating an integrated circuit, the method comprising:
reading an I_{DDQ} Vector Analysis (IVA) format definition of at least one power domain of the integrated circuit;
simulating cells of the integrated circuit using the IVA format definition of at least one power domain of the integrated circuit; and
at least one of (1) displaying results of the step of simulating and (2) storing the results of the step of simulating.

49. A computing system comprising at least one processor and at least one memory storing instructions, wherein, when the instructions are executed by the at least one processor, the processor configures the computing system to perform a method of performing leakage current testing of an integrated circuit, the method comprising:
reading an I_{DDQ} Vector Analysis (IVA) format definition of at least one power domain of the integrated circuit;
driving the integrated circuit with predetermined vectors;
determining leakage current of cells of the integrated circuit using the IVA format definition of at least one power domain of the integrated circuit; and
at least one of (1) displaying results of the step of simulating and (2) storing the results of the step of simulating.
